(19) United States
(12) Patent Application Publication
(10) Pub. No.: US 2016/0149768 A1
(43) Pub. Date: May 26, 2016

(54) AUTOMATIC COMPLETION OF FAILED SELF-CARE RESOLUTION ATTEMPT FOR INTERACTIVE SYSTEMS

(71) Applicant: AT&T INTELLECTUAL PROPERTY I, L.P., Atlanta, GA (US)

(72) Inventors: Alireza HOOSHIARI, ALPHARETTA, GA (US); James W. FAN, San Ramon, CA (US)

(73) Assignee: AT&T INTELLECTUAL PROPERTY I, L.P., Atlanta, GA (US)

(21) Appl. No.: 14/554,541

(22) Filed: Nov. 26, 2014

(51) Int. Cl. H04L 12/24; H04L 12/26

(52) U.S. Cl. CPC H04L 41/22; H04L 43/10

(57) ABSTRACT

A system receives a communication from a user via a first communication channel used by users to automatically resolve an issue. The system monitors, using a processor of a computer, interaction between the user and the system during the communication. Then, as a result of the monitoring, a failed attempt by the user to resolve an issue is identified. The failed attempt is categorized into one of a plurality of categories for each of which a different option for establishing a second communication to resolve the issue is provided. A second communication is then established with the user via a second communication channel distinct from the first communication channel, in accordance with the categorizing, to resolve the failed attempt.

### BACKGROUND

1. Field of the Disclosure

The present disclosure relates to the field of customer care systems. More particularly, the present disclosure relates to automatically completing a failed attempt of a user to resolve an issue using a self-care system.

2. Background Information

Interactive systems offer customers/users an avenue to resolve issues with respect to a variety of call center issues. Interaction with these systems by users can leave some issues unresolved.

### BRIEF DESCRIPTION OF THE DRAWINGS

FIG. 1 shows an exemplary general computer system that includes a set of instructions for customer self-care systems;

FIG. 2 shows an exemplary network for a self-care system, according to an aspect of the present disclosure;

FIG. 3 shows an exemplary logic flow for a self-care system, according to an aspect of the present disclosure;

FIG. 4 shows an exemplary process for a self-care system, according to an aspect of the present disclosure;

FIG. 5 shows an exemplary process for a self-care system, according to an aspect of the present disclosure;

FIG. 6 shows an exemplary process for a self-care system, according to an aspect of the present disclosure; and

FIG. 7 shows an exemplary communication flow for active records for interactive systems, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, any reference to claim elements in the singular, for example, using the articles “a,” “an” or “the”, is not to be construed as limiting the element to the singular.

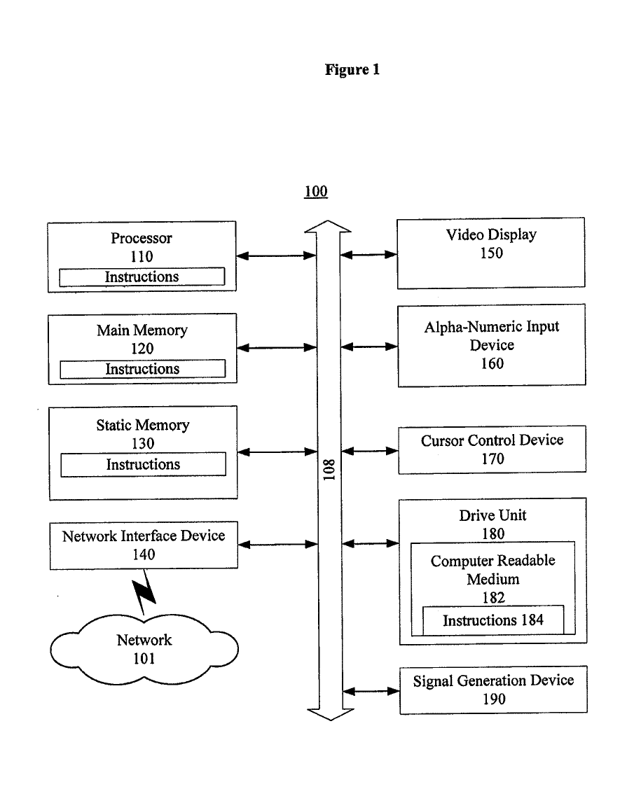

FIG. 1 is an illustrative embodiment of a general computer system, on which a method of a self-care interactive system can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as an call interceptor, an interactive voice response (IVR) system, a context manager, an enrichment sub-system, a message generator, a message distributor, a rule engine, an IVR server, an interface server, a record generator, a data interface, a filter/enhancer, a script engine, a private branch exchange (PBX), stationary computer, a mobile computer, a personal computer (PC), a laptop computer, a tablet computer, a wireless smart phone, a personal digital assistant (PDA), a global positioning satellite (GPS) device, a communication device, a control system, a web appliance, a network router, switch or bridge, a web server, or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, distributed processors, parallel processors, or all three. Multiple processors may be included in, or coupled to, a single device or multiple devices. When a processor executes instructions to perform operations, this could include the processor performing the operations directly and/or facilitating, directing, or cooperating with another device or component to perform the operations.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory describe herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted.

As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen or pad. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101. Further, the instructions 184 may be transmitted or received over the network 101 via the network interface device 140.

A self-care system as described herein includes any of a variety of self-care channels such as an IVR, a web portal, a chat service, a text messaging service, and/or an email service configured for a user (and/or customer) to perform self-care functions including ordering products and services, troubleshooting products and services, modifying services, and upgrading services, etc. In the event that a user interacting with the system fails at an attempt to complete a self-care task via a first communication channel such as a web portal, the self-care system can contact the user via a second communication channel (alternative self-care channel) distinct from the first communication channel to complete the self-care task, beginning at a point at which the user finished interacting with the system. While a web portal is the exemplary tool described herein, the other methods discussed above are equally applicable and may be used in lieu of or in addition to a web portal.

For example, if for some reason, such as lack of insufficient information, user error, or user distraction or indecision, a user is unable to complete a self-care task using the web portal (first communication channel), the attempt by the user is deemed unsuccessful. The attempt of the user may be unsuccessful for either voluntary or involuntary reasons of the user. Thus, rather than having the user completely give up or place a call to a call center, the present system monitors the self-care activities of the user via the web portal in the event of a failure to resolve the issue, and then proactively attempts to contact the user via an IVR (second communication channel) in order to resolve the issue, e.g., complete the unfinished task. The self-care activities can be monitored in real-time or the monitoring thereof can be delayed (i.e., a lag time) by a predetermined amount of time. Thus, the user web portal activities are monitored.

A session initiation protocol (SIP), which is a signaling communication protocol, may be used to initiate and control communication sessions. That is, session initiation protocol messages can be used to initiate and control communication sessions such as voice and video calls over Internet Protocol (IP) networks.

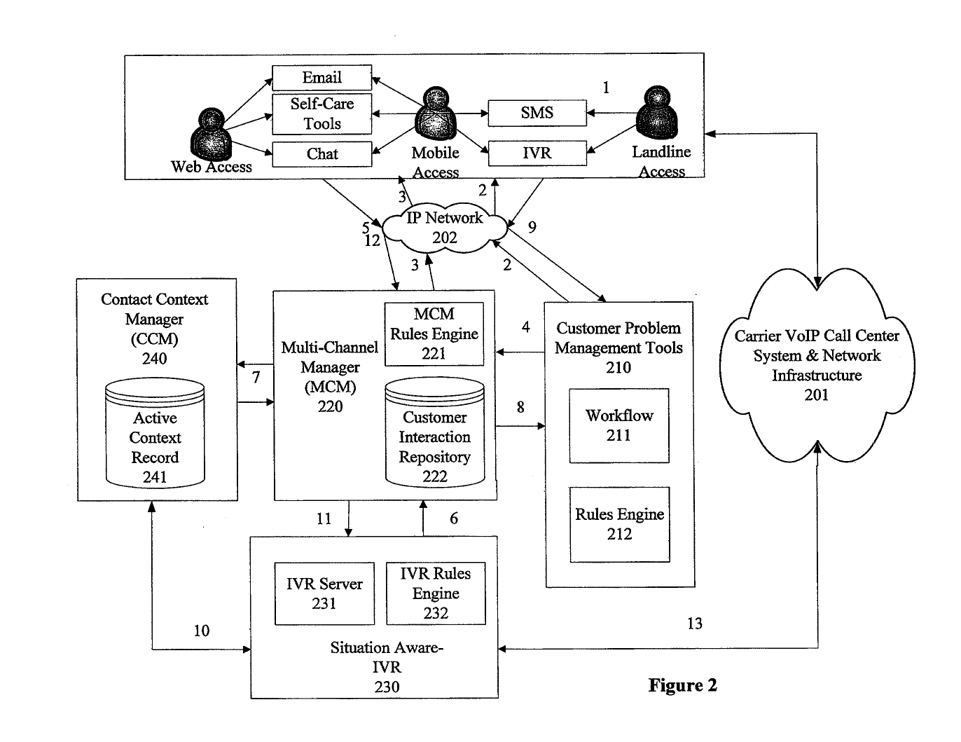

FIG. 2 shows an exemplary network for a self-service care system, according to an aspect of the present disclosure. In FIG. 2, an overview is provided for a network that includes customer problem management tools 210, a multi-channel manager (MCM) 220, a situation aware IVR 230, and a contact context manager (CCM) 240. The customer problem management tools 210 include a workflow 211 and a rules engine 212. The multi-channel manager 220 includes a rules engine 221 and a customer interaction repository 222. The situation aware IVR 230 includes an IVR server 231 and an IVR rules engine 232. The contact context manager 240 includes an active context record database 241.

In FIG. 2, Internet (web) access, mobile access, and/or landline access is provided for communications between the user via a user device and the customer problem management tools 210 and the multi-channel manager takes place via a suitable network such as IP network 202. Web access may include a web portal accessed over the IP network 202, through which the user can interact and attempt to self-resolve an issue with the system. The web portal runs on a server that delivers content, and provides a point of entry for at least one website and back-end applications that are accessible and viewable to a user via a web-enabled device. Communication with the portal can be achieved via one or more web application programming interfaces (APIs). Through self-care tools, a user is able to perform functions and interact with the system, with respect to products and services available through the provider. Alternative ways to interact with the self-care system include chat, email, text messaging, or via IVR. Communications between the user and the situation aware IVR 230 take place via a carrier voice over internet protocol (VoIP) network 201 to access a self-care call center system and network infrastructure through the situation aware IVR 230.

The voice over internet protocol network 201 is representative of a modern telecommunication carrier network. Such modern telecommunication networks may include legacy service control points from the legacy advance intelligent network, or may include more modern alternative messaging controllers. Session initiation protocol messages may be transmitted through a stand-alone messaging network used to control a telecommunication carrier network, or may be transmitted through the same data network that is used to carry, e.g., voice communication, over a telecommunication carrier network. Additionally, while session initiation protocol has been in use for a time, any alternative messages with a similar purpose and function of initiating communication can be used in the same manner as session initiation protocol messages. The carrier network 201 may of course be a different kind of communication network such as a cellular network, a conventional public switched telephone network or advanced intelligent network, a cable network and so on. Additionally, a combination of different kinds of networks may be used instead of a particular carrier voice over internet protocol network.

Additionally, although not shown for every embodiment, an automated call distributor (ACD) may be used to distribute calls for both concentrated and distributed call centers. An automated call distributor may serve as an interface between the voice over internet protocol network 201 and a call center that includes the situation aware IVR 230.

The customer management problem tools platform 210 includes a rules engine 212 that accesses troubleshooting and problem resolution flows and provides responsive information related to such flows to a user accessing the web portal. The customer management problem tools platform 210 interacts with the user based on rules provided by the rules engine 212.

The multi-channel manager 220 includes a repository for interaction among all communication channels of the user, and acts as a director to direct the situation aware IVR 230 to initiate an outbound IVR call to the user. The multi-channel manager 220 can include a variety of subsystems as needed and determines what methods shall be used to resolve the failed web portal attempt by the user. The multi-channel manager 220 includes the rules engine 221 that uses an active context record 241 and information obtained from monitoring user interaction with the web portal (or IVR) to determine the next course of action. The rules engine 221 of the multi-channel manager 220 governs the methods and fashion in which the user issue will be resolved. Additionally, the multi-channel manager 220 monitors all transactions through the web portal, and based upon various conditions, determines whether a follow-up contact (i.e., an outbound IVR call) with the user via the second communication channel (alternative self-care channel) would be appropriate to resolve the issue.

The outbound IVR call initiated by the multi-channel manager 220, with support from the active context record 241 and the contact context manager 240, may be leveraged by other communication channels, including self-service communication channels (e.g., (web, email, text messaging) and/or assisted channels (e.g., call center agents, chat agents) and/or social media channels).

The multi-channel manager 220 monitors and records all of the transaction of users contacting the customer problem management tools 210 platform. If it is determined that the user has an unsuccessful attempt to resolve an issue, an alternative self-care channel such as an outbound call by the situation aware IVR 230 is contemplated by the system. Based on factors such as timeouts, idle behavior patterns, transaction stage during termination, simplicity of the issue to be resolved, and other channel activities immediately after the termination of the web portal session of the user, the rules engine 221 determines whether an IVR outbound call is appropriate via the situation aware IVR 230.

An auto-collaborative channel relay can be used to assist in the resolution of the user issue, including ordering products or service, upgrading products or services, modifying services, upgrading services, scheduling service, performing test of user products or services, etc.

If the rules engine 221 determines that an IVR outbound call is appropriate, contextual information gathered during the user's unsuccessful attempt to resolve an issue is used to make a decision as to the best mode of communication and at what communication address in which to contact the user. For example, this may be a landline communications address, a mobile phone communication address, etc. The contextual information gathered during the user's unsuccessful attempt to resolve an issue is gathered and stored as an active context record (ACD) 241 in a database accessible by the contact context manger 240.

At the situation aware IVR 230, an IVR server 231 is used to provide interactive services to the user across the carrier voice over internet protocol network 201. The communications between the user and any IVR described herein are bidirectional, wherein speech may be both sent and received simultaneously by the user and IVR. A conventional IVR provides interactive services using a predetermined hierarchical script in which sequential prompts are varied based on each input or lack of input by a user. As an example, a particular script is conventionally selected based on a telephone number dialed by a user. A situation aware IVR 230 however selects a script in part based on the context information provided by the contact context manager 240.

The IVR server 231 interacts with the user based on rules provided by IVR rules engine 232. The IVR rules engine 232 analyzes context information provided during interaction with the user and either alters the selection of a script or varies the prompts in a script based on the context information rather than only on any particular input provided by the user. Variations to a script can include additions or deletions of prompts, rearrangement of an order in which prompts are played, creation of an entirely new and even unique prompt to play first to a user before presenting any list in a script, or other forms of variations to a script.

The situation aware IVR 230 can select a script based on context information provided during interaction with the user. The script may already be personalized for the caller based on an active context record 241 associated with user, such as by periodic updating. The IVR rules engine 232 may also dynamically obtain and receive information from other sources that help to determine whether and when to alter the selection of a script or vary the prompts in a particular script. In this regard, the IVR rules engine 232 receives input from a contact context manager 240, which in turn receives application protocol interfaces from enterprise call center internal customer data/business processes. The active context record 241 relays current contextual data to assist the situation aware IVR 230 in the outbound IVR call.

The contact context manager 240 provides contextual information to the situation aware IVR rules engine 232. The contact context manager 240 also captures user information from both internal and external sources in order to generate an active context record 241. Additionally, the contact context manager 240 active context record 241 contains relevant customer data including context data gathered during the failed attempt of the user to resolve the issue. The user information in the context manager 240 includes information as to the best communication address (e.g., phone number) to reach the user.

A combination of contextual information in the active context record 241 and data obtained from the user interaction of the failed attempt are used to determine the nature of the user issue and the categorization of the same. The contextual information in the active context record 241 used in this regard can be one or more of prior user contact information, problem history associated with the user; problem history of products or services of the user, etc. The contextual information, with or without data from the user interaction of the failed attempt are passes to the customer interaction repository 222 for storage.

It should be clear that the contact context manager 240 uses the session contextual data and the data gathered in the customer interaction repository 222 to create and/or update the active context record 241.

The architecture allows the system to monitor user interaction with the self-care channels. The monitoring allows the system to determine whether particular interactions with the self-care channels are successful or not. By successful, it is meant that the user has resolved the issue about which the interaction was related.

If a particular interaction with the web portal is not successful, meaning that the user did not resolve an issue, then the user interaction with the self-care channel is recorded in the work flow 211 of the customer problem management tools 210 platform. The recorded interaction is passed to the multi-channel manager 220 and is stored in the customer interaction repository 222, where interaction concerning all communication channels may be stored.

For example, the data passed to the multi-channel manager 220 and stored in the customer interaction repository 222 includes presence information. The presence information includes whether the user is still using the device (or another device) from which the user initiated the contact with the web portal. In this regard, user device activity information is provided via a network connection to, for example, an operator and/or owner of the customer problem management 210 tools platform. In one embodiment, the presence information may be obtained by the multi-channel manager 220 or a separate presence server. In another embodiment, the presence monitoring may be obtained by the customer management tools 210, or other network element connected to the IP network 202. For example, the multi-manager 220, the customer problem management tools 210, a presence server, or equivalent, can monitor user activity via a user the IP network 202 or similar network, such as that for broadband Internet, IP telephone, and/or IP television (IPTV), etc. For example, television (tv) content may be delivered to a user via a fiber-to-the-node or fiber-to-the-premises communications network, that may monitored by such a server. Similarly, Internet, mobile phone, email, and landline phone activity may be monitored by such a presence server or equivalent. Presence information may alternatively be collected via another party or service, which would convey the presence information to the operator and/or owner of the customer problem management tools 210 platform.

Additional data passed to the multi-channel manager 220 includes a state of the self-care work flow prior to termination of the self-care attempt by the user, an activity log from the self-care web tool to include a list of user activity prior to terminating the self-care attempt (e.g., leaving the web portal website), and an IVR log prior to terminating the self-care attempt.

The rules engine 221 in the multi-channel manager 220, or subsystems thereof, determines what methods shall be used to resolve the issue. The rules engine 221 in the multi-channel manager 220 accesses the active context record 241 from the contact context manager 240, along with the information obtained via monitoring web portal and IVR in order to determine the next course of action. Thus, the resolution of the user issue is based on a set of rules engine 221 of the multi-channel manager 220.

In one non-limiting example, the web portal may provide the user with secure access to information of the user. For example, the user may access the web portal via an application on a user device or by using a user device to select a link or other application that will direct the user to a website where the web portal can be accessed. The user request to enter the web portal may include a request to authenticate the user of the user device, prior to establishing a communication session. For example, the user may be prompted to input login credentials. Authentication information input by the user may be transmitted to a module for evaluation and approval. Once the user authentication information has been validated, the user is granted access to the web portal.

Once the user is granted access to the web portal, the user interacts with the customer problem management tools 210. The web portal may provide a guided tutorial or flow through which to assist the user in resolving the issue. The user can attempt to perform various tasks, including ordering a product or service, modifying a service, troubleshooting a product or service, etc. This interaction takes place in the workflow 211 module of the customer problem management tools 210. That is, the user can attempt to navigate through options, menus, text input boxes, links, on at least one display screen of the portal, where the user can provide visual, graphic, and/or audio information. In exchange, information is sent to the user device for display by the customer problem management tools 210. The customer management tools 210 can interact with appropriate back end systems (e.g., an auto-collaboration channel relay) in order to provide processing for product ordering, service modifications, etc.

It should be clear in FIG. 2, that the various components, elements, and subsystems (and names thereof) are for illustrative purposes, and that any suitable components, elements, and subsystems may be substituted to accomplish the functions indicated.

At step 1, a user accesses the self-care system via customer problem management tools 210 over IP network 202 by, for example, web access, mobile access, or landline access. As a non-limiting example, the user may access the customer problem management tools 210 via the web portal to order a product or service, troubleshoot a product or service, or modify a product or service. Once the user is authenticated during an optional login and verification procedure, the user interacts with the customer problem management tools 210 to address an issue of the user, indicated as step 2 in FIG. 2. The user interaction with the customer problem management tools 210 may involve self-care tools, which may serve as an interface to the customer problem management tools 210. Also at step 2, contextual information from self-care tool logs is passed to the contact context manager 240 and stored in the active context record 241. That is, the active context record 241 is updated based on the user interaction with the customer management tools 210, either during or after the interaction.

At some point during interaction with the customer problem management tools 210 platform 210, the multi-channel manager determines that the user failed to resolve the issue, that is, a task that the user sought to complete remains incomplete. The failure to resolve the issue is detected by the multi-channel manager 220 at step 3.

During interaction between the user and the customer problem tools platform 210, the multi-channel manager 220 obtains a workflow 211, which is passed from the customer problem management tools 210. The workflow 211 includes a script of the interaction between the user and the customer problem management tools 210. The rules engine 212 governs the interaction between the user and the customer problem tools platform 210. The rules engine 212 may be a software component that contains the necessary logic to carry out a sequence of operations associated with data to carry out a particular rule. Thus, the owner or operator of the self-care system can change the rules within the rules engine as needed or desired.

Referring back to FIG. 2, the multi-channel manager 220 monitors the interaction between the user and the customer problem tools platform 210. For example, the multi-channel manager 220 monitors all web transactions (e.g., web portal transactions) between the user and the customer problem tools 210. By monitoring all of the transactions between the user and the customer problem tools 210, the multi-manager 220 may ascertain whether the user's self-care attempt is successful. When the multi-manager 220 determines that the user's self-care attempt is not successful, a series of events occur.

That is, at step 4, the customer problem tools platform 210 passes the workflow 211 information to the multi-channel manager 220. The workflow 211 data includes a state of the self-care workflow attempt between the user and the customer problem management tools platform 210. The workflow 211 data obtained by the multi-channel manager 220 also includes presence information as to whether the user is still on the website or logged into the web portal. At step 5, an activity log from the self-care web tools used by the user, which includes a list of user activities prior to a determination (e.g., the user left or exited a session with the web portal) that the user's self-care attempt is unsuccessful, is obtained by the multi-channel manger 220. An IVR log is passed to the multi-channel manager 220 if the user contacted the self-care system via an IVR, at step 6.

Since the user failed to resolve the issue with the self-care system, the system will determine the best method in order to complete the task and resolve the issue for the user. More specifically the rules engine 221 in the multi-channel manager 220 will determine whether the self-care system can complete the task for the user, and thus resolve the issue, that is, does this user task/issue qualify as an outbound IVR candidate (i.e., can the system resolve the user issue). The rules engine 221 may be a software component that contains the necessary logic to carry out a sequence of operations associated with data to carry out a particular rule. Thus, the owner or operator of the self-care system can change the rules within the rules engine 221 as needed or desired.

In order to make the outbound IVR candidate qualification decision, the rules engine 221 of the multi-channel manager 220 may review a length of the user session, the simplicity of the issue to be resolved, user inactivity during the session (e.g., idle time), a timeout condition when a user fails to respond to a prompt, the nature of a task being performed by the user immediately before the user terminated the session, messages or comments left by the user during the session, emails or other subsequent communications from the user, or activities by the user via other communication channels after session termination (i.e., if the user session was via web access, did the user use a mobile phone or the Internet; is the user using the Internet, is the user's television service in operation). All of these factors may be considered by the multi-channel manager 220 in qualifying an outbound IVR candidate.

Once the rules engine 221 of the multi-channel manager 220 qualifies the user issue as an IVR outbound candidate, the rules engine 221 can determine what methods will be employed to complete the self-care session in order to resolve the user issue. To begin with, at step 7, the rules engine 221 requests and obtains an active context record 241 from the contact context manager 240 to determine how to resolve the issue, i.e., complete the user task. As noted above, the active context record 241 is updated based on the user interaction with the customer management tools 210, either during or after the interaction. Then, at step 8, based on the monitoring of the session performed by the multi-channel manger 220, and the active context record 241 acquired from the contact context manager 240, the rules engine 221 of the multi-channel manager 200 determines the course of action.

Typically, an outbound IVR call would be the preferred next contact with the user. However, a live agent and/or IRC bot may also be used to the contact the user, or a combination of an outbound IVR call, live agent, and/or IRC bot may be used, depending upon the circumstances.

For example, according to the rules engine 221, if the user still remains on the web portal website, and the issue is not resolved, then an IVR outbound call can be made to the user. If the user has navigated away from web portal website, then an email or text message may be sent to the user with a completion code (i.e., an identifier). The email message or text message containing the completion code identifier may include a link or phone number to an IVR application which would connect the user with an IVR such as the situation aware-IVR 230. If the user has navigated away from the web portal website, then an email or text message may be sent to the user requesting permission for the self-care system to resolve the issue (i.e., complete the task) automatically without intervention or further contact of the user.

A delay mechanism may be employed such that the email or text message is not sent to the user immediately. For example, presence information may be used to determine when to send the email or text message to the user. That is, if the user was attempting to resolve an issue with tv service during the user's failed self-care attempt, then the delay mechanism may provide that the email or text message requesting permission be sent when the user is engaging in a known activity, for example, using a mobile phone, browsing the Internet, watching tv, changing a tv channel, etc. As another example, a delay mechanism may be employed in order to monitor other communication channels of the user to determine if the user has sent an email or has attempted to initiate a chat session in order to resolve the issue, at which time the email or text message requesting user permission would be sent.

For example, the user may be contacted with an outbound IVR call by the situation aware IVR 230 after a predetermined delay after the failed attempt, in which user email activity is monitored (using presence monitoring) during the delay, for example, for outgoing emails concerning the issue to be resolved, or with the product or service pertaining to the issue to be resolved. As another example, the user may be contacted with an outbound IVR call by the situation aware IVR 230 after a predetermined delay after the failed attempt, in which user text messaging activity is monitored (using presence monitoring) during the delay, for example, for outgoing text messages concerning the issue to be resolved, or with the product or service pertaining to the issue to be resolved.

With respect to the presence information, such information may be obtained when a user device registers or accesses a network of the service provider, e.g., is the user using a mobile phone, is the user texting or engaged in a call, is the user using the Internet, is the user tv in operation indicating that the user may be watching tv, is a user set-top box ON, what content is the user watching on tv, etc. The service provider may be the owner or operator of the self-care system. The user may or may not have to grant advance permission that such presence information is obtained by the service provider.

At step 9, an outbound IVR call with the situation aware IVR 230, under the direction of the IVR server 231, is placed to the user in order to resolve the issue. Alternatively, a completion code is sent from the customer problem management tools platform 210 to the user. The completion code sent to the user may be used to reconnect the user with the self-care system to resolve the issue, i.e., complete the unfinished task. For example, the user may call into the system and be connected with the situation aware IVR 230 where the user will provide the completion code to the situation aware IVR 230. Alternatively, the situation aware IVR 230, under the direction of the IVR server 231, may place an outbound IVR call to the user at a time specified to the user in a message that accompanied the completion code.

No matter how the user is connected again with the self-care system (i.e., outbound IVR call to user, user contacts self-care system again using the completion code), a seamless resolution is achieved, in that the self-care system resumes interaction with the user with the last task performed by the user during the unsuccessful attempt by the user to resolve the issue. This is achieved by active context record 241 and the customer activity log from the self-care tools being passed to the situation aware IVR 230 at steps 10 and 11, the former being received from the contact context manager 240 and the latter being received from the customer interaction repository 222.

Accordingly, the need for the user to input or provide information previously provided during the unsuccessful attempt to resolve the issue is eliminated. Further, the need for the user to repeat tasks previously performed during the unsuccessful attempt to resolve the issue is eliminated.

If an outbound IVR call is not sent to the user immediately following the user's failed attempt to resolve the issue, then the completion code or request for permission to complete the task to resolve the issue without further input from the user is carried out at step 12. Then, the outbound IVR call is placed to the user at step 13 over the carrier VoIP call center system & network infrastructure 201.

If the completion code method is used, then when the use calls the self-care system, the user is connected with the situation aware IVR 230, which using an appropriate interactive script, can solicit the completion code from the user in order to match the user's with the previous attempt by the user to resolve the issue. If, rather than calling into a number, the user accesses the system to complete the task by clicking a link, then it may not be necessary for the user to enter the completion code, as the link will contain the necessary information to serve to identify the user and the issue to be resolved.

The situation aware IVR 230 is configured to place a call to the user and follow a script beginning where the user left off in the procedure to resolve the issue. In the event that the user is not available or if it is determined not to contact the user immediately (based upon a rules decision), a text message and/or email message is sent to the user, along with a completion code identifier. Upon receipt of the completion code, the user can call the situation aware IVR 230 at any time and provide the completion code. Upon recognizing the completion code, the situation aware IVR 230 follows an interactive script to guide the user to complete the task required to resolve the issue. A text message or email message can also be forwarded to the user asking for permission to automatically resolve the issue on behalf of the user. If permission is not received from the user, the process proceeds with one of the aforementioned methods of resolving the issue.

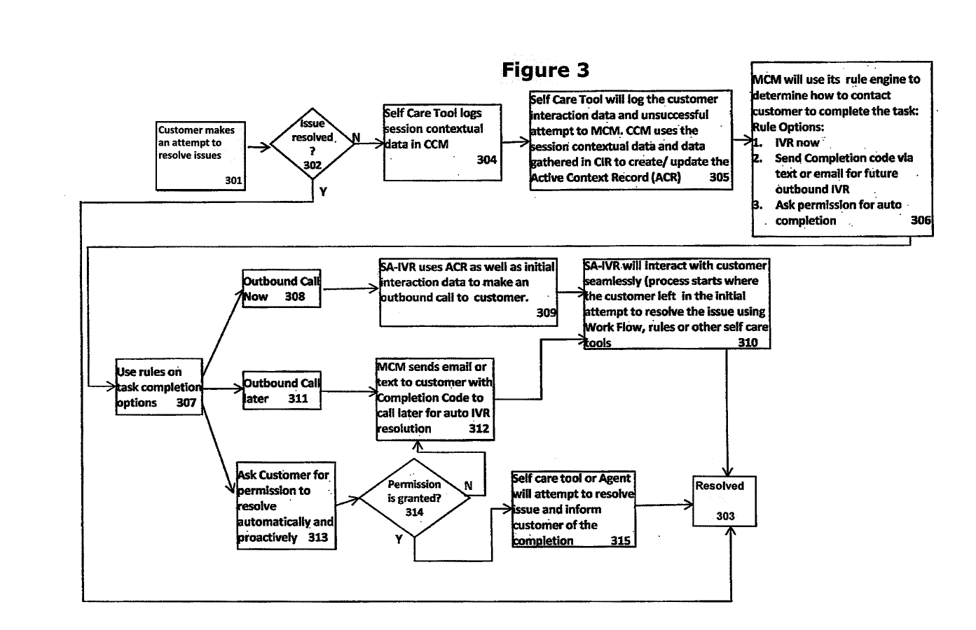

FIG. 3 is a flow diagram illustrating a communications flow for completing a self-care task, according to an aspect of the present disclosure. At step 301, the user attempts to resolve at least one issue using the web portal. The issue may be to order products or services, troubleshoot products or services, modify services, etc. If a determination is made by the multi-channel manager 220 at step 302 that the issue is resolved, then a resolution status is recorded by the multi-channel manager 220 and passed to the customer interaction repository at step 303. However, if a determination is made by the multi-channel manager 220 at step 302 that the issue is not resolved, then processing proceeds to step 304. Various reasons may exist for the issue not having been resolved by the user, including lack of information available to the user, lack of understanding by the user, lack of familiarity by the user, the user becoming distracted, etc, as discussed previously.

At step 304, a self-care tool logs the user contact session as contextual data in the contact context manager 240. Then, at step 305, the self-care tool will log the customer interaction data and the unsuccessful attempt in the multi-channel manager 220. The contact context manager 240 uses the session contextual data and the data gathered in the customer interaction repository 222 to create and/or update the active context record 241. At step 306, the rules manager 221 in the multi-channel manager 220 determines how to contact the customer to complete the task in order to resolve the issue. According to the rules engine 221 of the multi-channel manager 220, a) an outbound IVR call may be placed to the user at this time; b) a completion code may be sent to the user via email or text message for a future outbound IVR call; or c) the user may be asked for permission to have the issue resolved automatically without further intervention of the user. In an alternative embodiment, resolution of the issue may be performed automatically by the system without any contact with the user after the failed web portal attempt of the user. In this regard, the automatic completion of the issue may occur immediately after the unsuccessful attempt of the user, or it may occur at a later time, for example, when the user is either using a user device or when the user device not being used, as ascertained by presence monitoring of devices and networks available to the user.

At step 307, the rules engine 221 of the multi-channel manager 220 may employ a variety of factors in order to decide which of the above methodologies will be employed to facilitate resolution of the issue. For example, the nature of the issue to be resolved may be the primary factor in deciding how to proceed. That is, for a task that is relatively easy and quick to complete or that appear to be urgent, the rules engine 221 may determine that an outbound IVR call should be placed to the user immediately or after only a short time has elapsed. For issues that do not require additional input from the user, the rules engine 221 may determine that the user should be asked for permission to have the issue resolved automatically without further intervention of the user. For issues that require some input from the user and that are not determined to be urgent, the rules engine 221 may determine that a completion code may be sent to the user via email or text message for a future outbound IVR call or other communication with the user. The rules of the rules engine 221 are determined according to rules determined by, for example, the owner or operator of the system.

At step 308, an outbound IVR call is placed to the user. At step 309, the situation aware IVR 230 uses the active contact record 241, as well as information obtained from the unsuccessful attempt by the user to resolve the issue, in order to make an outbound IVR call to the user. In response the contacting of the user by the situation aware IVR 230, the situation aware IVR interacts with the user in a seamless fashion. That is, the situation aware IVR 230 interacts with the user beginning at a point in the process at which the user left off in attempting to resolve the issue. Thus, the user does not have to re-enter information or repeat steps that the user entered or performed during the unsuccessful attempt to resolve the issue. The situation aware IVR 230 uses the work flow 211, rules engine 212 of the customer problem management tools 210 or other self-care tools to resolve the issue of the user. If the issue of the user is resolved, control proceeds to step 303 where the process is terminated. When the process is terminated, the active context record 241 and the customer interaction repository 222 are updated accordingly.

If it is determined that an outbound IVR call should later be placed to the user or received from the user at step 307, the processing proceeds to step 311. At step 312, the multi-channel manager 220 sends an email or a text message to the user with a completion code requesting that the user call in at a later time to receive an auto IVR resolution. Alternatively, the multi-channel manager 220 may send the user an email or a text message that an outbound IVR call will be placed to the user at a particular time. At step 310, the situation aware IVR 230 interacts with the user in a seamless fashion. That is, the situation aware IVR 230 interacts with the user beginning at a point in the process at which the user left off in attempting to resolve the issue. The situation aware IVR 230 uses the work flow 211, rules engine 212 of the customer problem management tools 210 or other self-care tools to resolve the issue of the user. If the issue of the user is resolved, control proceeds to step 303 where the process is terminated.

Depending upon the decision at step 307, at step 313 it is determined that the user should be asked for permission to resolve the issue automatically and proactively. If the user grants permission at step 314, the self-care tool or agent will attempt to resolve the issue and inform the customer of the completion at step 315. If the issue of the user is resolved, control proceeds to step 303 where the process is terminated. On the other hand, if the user does not grant permission at step 314, control proceeds to step 312. At step 312, the multi-channel manager sends an email or a text message to the user with a completion code to call later to receive an auto IVR resolution. At step 310, the situation aware IVR 230 interacts with the user in a seamless fashion. That is, the situation aware IVR 230 interacts with the user beginning at a point in the process at which the user left off in attempting to resolve the issue. The situation aware IVR 230 uses the work flow, rules engine of the customer problem management tools or other self-care tools to resolve the issue of the user. If the issue of the user is resolved, control proceeds to step 303 where the process is terminated.

Several scenarios exist for proceeding based upon the data monitoring and contextual data. In a first scenario, the rules engine 221 determines that the unresolved issue of the user may be resolved without any further input from the user. The rules engine 211 performs an analysis of the unresolved issue and may determine that the unresolved issue may be resolved relatively easily without initiating a contact to the user. For example, if the user was attempting to reset a password, the multi-channel manager 220 may instruct the customer problem management tools platform to initiate a process to reset the password. After the password has been reset, a message is sent to the user notifying that the password has been reset. The rules engine 221 may determine that the unresolved issue may be resolved, but that the permission of the user is required to resolve the issue. In this event, an IVR outbound call is placed to the user at a communications address stored in the active contact record 241. The IVR outbound call of the situation aware IVR, when answered by the user begins a script in which authorization to resolve the issue is solicited from the user. Once the authorization of the user is obtained, the IVR outbound call is terminated, and the customer management tools 210 platform resolves the issue, e.g., resetting a password. Of course, the IVR outbound call need not be a call per se, but may be an email, text message, chat, etc.

The IVR server 231 directs that the situation aware IVR 230 interacts with the user based on rules provided by IVR rules engine 232. The IVR rules engine 232 analyzes context information provided and either alters the selection of a script or varies the prompts in a script based on the context information rather than only on any particular input provided by the user. Variations to a script can include additions or deletions of prompts, rearrangement of an order in which prompts are played, creation of an entirely new and even unique prompt to play first to a user before presenting any list in a script, or other forms of variations to a script.

The situation aware IVR 230 can select a script based on context information provided via an enhanced session initiation protocol message. The script may already be personalized for the caller based on an active record maintained for the caller, such as by periodic updating. The IVR rules engine 232 may also dynamically obtain and receive information from other sources that help to determine whether and when to alter the selection of a script or vary the prompts in a particular script. In this regard, the IVR rules engine 232 receives input from the contact context manager 240. As such, a situation aware IVR 230 may execute a personalized interactive script based on both predetermined template scripts, information provided automatically at the time of a call, profile information maintained by the entity, and the contextual active records that are built and actively maintained for the entity for use in personalized interactive communications.

The IVR server 231 agrees to accept an incoming call from a user and sets up the incoming call for processing, and the IVR rules engine 232 identifies a script to use and any appropriate modifications to make to the script based on, for example, the information provided in the header of the modified (enriched) session initiation protocol message.

For example, a script may be modified to ask the user to disconnect a router, and to indicate when the user has performed unplugging the router. Any other necessary information may be presented to the user and the user may be asked to simply state whether any of the other information is incorrect. In this way, processing time may be greatly reduced.

As noted, the situation aware IVR 230 can select a script based on context information provided via the contact context manager 240. The IVR rules engine 232 may dynamically obtain and receive information from other sources that help to determine whether and when to alter the selection of a script or vary the prompts in a particular script. In this regard, the IVR rules engine 232 receives input from a contact context manager 240, which in turn receives application protocol interfaces from enterprise call center or internal customer data/business processes.

Context information may include many different types of data including basic information such as caller profile information, location, subscription information, known preferences, and information suggestive of a reason the caller may be calling.

As such, a situation aware IVR 230 may execute a personalized interactive script based on both predetermined template scripts, information provided automatically at the time of a call, profile information maintained by the entity, and the contextual active records that are built and actively maintained for the entity for use in personalized interactive communications.

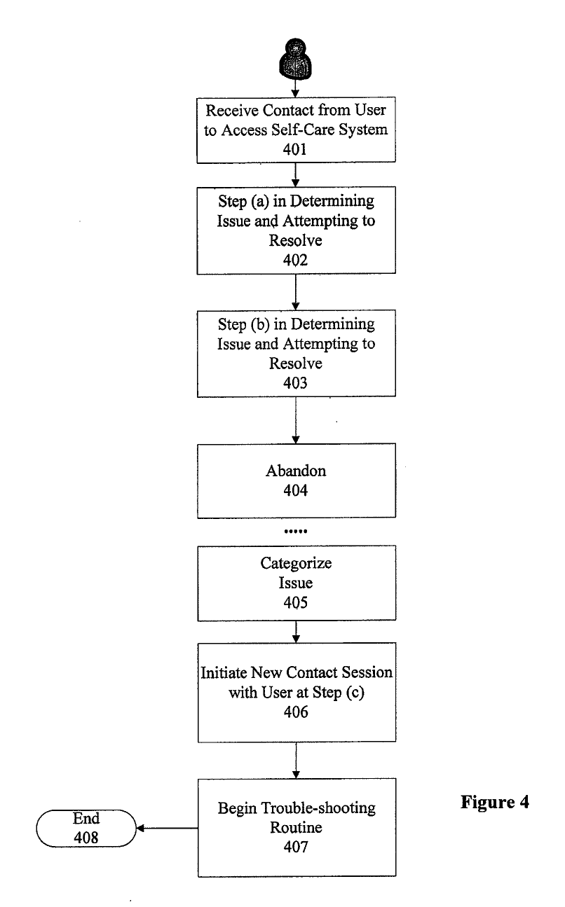

FIG. 4 shows an exemplary process for a customer self-care system, according to an aspect of the present disclosure. At step 401, a user accesses the self-care system to resolve an issue. The self-care system may be reached via a web portal, chat feature, email, or IVR. In FIG. 4, an exemplary issue to be resolved is to test a user device. For example, the user device may be a mobile phone, router, modem, television, set-top box, or other hardware of a user. At step 402, the user begins interacting with the self-care system to attempt to resolve the issue. For example, the user may select a “trouble with equipment” option. After selecting the “trouble with equipment option” the system interacts with the user to establish the cause of the trouble. For example, at step 403, the user is asked to restart or to turn OFF and back ON the user device in question. After restarting the router or performing the OFF/ON operation, at step 404, the user abandons the attempt to have the user device tested. For example, the user may lack familiarity with the system or not have enough information to have the issues resolved or may give up. While the user may abandon the session with the self-care system via exiting the system, other exemplary situations indicative of session termination are session length, inactivity by the user, the types of tasks being performed by the user immediately prior to session termination.

That is, if the multi-channel manager 220 detects that the length of the session between the user and the self-care system is unusually long, for example, over ninety minutes, then the multi-channel manager 220 may log the session as an unsuccessful attempt to resolve the issue. Similarly, if the multi-channel manager 220 detects an absence of keystrokes or other lack of audio input, visual input, commands, or input by a user in a given time period, for example, twenty minutes, then the multi-channel manager 220 would log the session as an unsuccessful attempt to resolve the issue. Likewise, if the multi-channel manager 220 detects certain types of tasks or user behavior being performed by the user immediately prior to session termination by the user, then then the multi-channel manager would log the session as an unsuccessful attempt to resolve the issue. Exemplary types of tasks or user behavior include the user accessing a help function, the user repeating the same steps or processes, the user repeatedly viewing the same web page, etc.

At step 405, after the multi-channel manager 220 has determined that the user had an unsuccessful attempt to resolve the issue, the rules engine 221 of the multi-channel manager 220 determines how to complete the user attempt at resolving the issue. For example, depending upon the rules established by the service provider, the rules engine 221 may decide whether to immediately resolve the issue without notifying the user, immediately place an outbound IVR call to the user, call the user via an outbound IVR call at a later time, send a completion code to the user for a later IVR call with the user, etc. Under the completion code scenario, the user could place a call to the IVR at a time of their choice, or alternatively, when the completion code is sent to the user, the message to the user would provide the user with a time when the outbound IVR would be placed to the user. The rules engine 221 may also decide to ask the user permission to automatically resolve the issue without further involvement from the user. If permission is granted, then the self-care tool or agent would attempt to resolve the issue and then notify the user of the completion of the task.

The rules engine 221 may categorize the issue to be resolved in terms of how urgent the issue is, how simple the issue is to be resolved, comments left by the user, messages left by the user, other activities initiated by the user after the session termination including phone calls, emails, or messages. For example, the rules engine determines that an issue is urgent (e.g., no service), then an outbound IVR call may immediately be placed to the user. If the rules engine determines that the issue may be easily resolved (e.g., user wishes to close an account), then the situation aware IVR 230 may direct that the account be closed without any input on the part of the user. If the rules engine 221 determines that, for example, an issue is more involved or that would require additional user input, then a customer code may sent to the user for the user to call at a later time. Alternatively, a time may be provided to the user as to when an outbound IVR call would be placed to the user.

In one embodiment, presence information is used to detect when a user is using a particular device. For example, a television service network provider may know when a user is watching tv, changing channels, watching certain stations, etc. In this scenario, the situation aware IVR 230 or IVR server 231 or other element may send a message to be displayed (e.g., a pop-up message) on the television of the user that would, for example, provide a user with a completion code, notify the user that an outbound IVR call to the user will be placed at a particular time, notify the user that the issue has been resolved. Of course, the presence information may be obtained with respect to user activity on other devices as well, including, mobile phones, landline phones, internet activity of the user, etc.

In the present example, at step 406, the IVR server 231 instructs the situation aware IVR 230 to immediately place an outbound IVR call to the user. When the user answers the outbound IVR call placed by the situation aware IVR 230, then the interactive scripts in the situation aware IVR 230 are used to interact with the user to resolve the issue. The situation aware IVR 230 uses information obtained in the active context record 241 and/or the customer interaction repository 222 to identify exactly where in the process the user had terminated the session, thus avoiding the need for the user to provide the same information again. In the present example, when the user answers the outbound IVR call placed by the situation aware IVR, then the situation IVR begins a troubleshooting routine script beginning with the next step in the process after step 403 to identify the source of the problem with a user device. For example, at step 407, the situation IVR 230, as part of its interactive script, would continue with a troubleshooting routine. Thus, the user is not asked to restart or perform the OFF/ON operation again. The next step in the troubleshooting routine may include sending a test signal to a user device, restarting a user device, instructing the user to disconnect and reconnect a user device, etc. The interaction with the user and the situation aware IVR 230 continues until the issue is resolved, and the interaction ends at step 408. Alternatively, the situation aware IVR may connect the user with a live agent after a predetermined number of steps have occurred without a successful resolution of the issue.

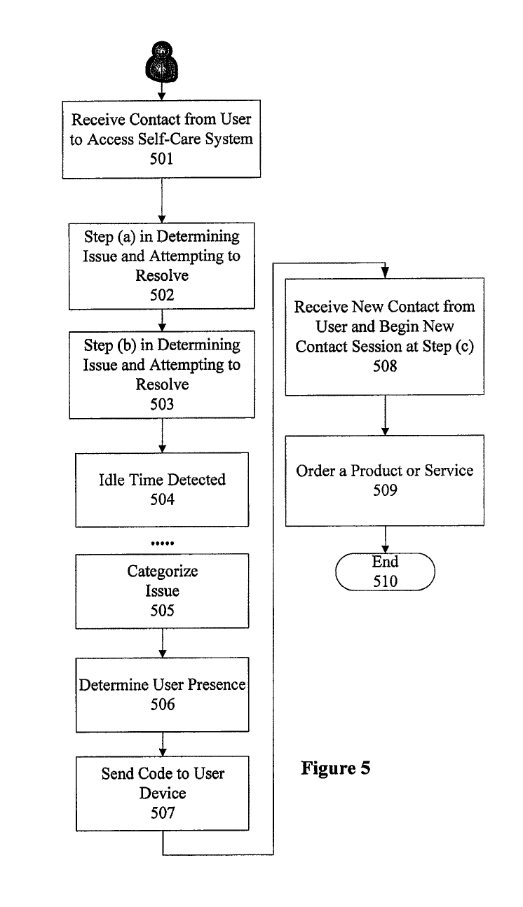

FIG. 5 shows an exemplary process for a customer self-care system, according to an aspect of the present disclosure. At step 501, a user accesses the self-care system to resolve an issue. The self-care system may be reached via a web portal, chat feature, email, or IVR. In FIG. 5, an exemplary issue to be resolved is to order a product. For example, the user device may wish to order a new phone or service. At step 502, the user interacts with the self-care system to attempt to resolve the issue, in this case, to purchase the product or service. For example, the user may select an option “purchase new phone”. At step 503, the user may interact with the user to attempt to elicit from the user which of a variety of phones the user would like to purchase. At step 504, the multi-channel manager detects an unusually high idle time on the part of the user, indicating that the user may lack familiarity with the system or not have enough information about the product or service in order to make an informed decision. For example, the user may not have enough information about the selection of phones available.

In the present example, the idle time is detected while the user appears to be attempting to purchase a product or service. For example, the user may have added a product or service to a virtual shopping cart, but had not completed the purchase and abandoned the session.

That is, if the multi-channel manager 220 detects an absence of keystrokes or other lack of audio input, visual input, commands, or input by a user in a given time period, for example, twenty minutes, then the multi-channel manager would log the session as an unsuccessful attempt to resolve the issue.

At step 505, after the multi-channel manager 220 has determined that the user had an unsuccessful attempt to resolve the issue, the rules engine 221 of the multi-channel manager 220 determines how to complete the user attempt at resolving the issue. For example, depending upon the rules established by the service provider, the rules engine 221 may decide whether to immediately resolve the issue without notifying the user, immediately place an outbound IVR call to the user, send a completion code to the user for a later IVR call with the user. Under this scenario, the user could place a call to the IVR at a time of their choice, or alternatively, when the completion code is sent to the user, the message to the user would provide the user with a time when the outbound IVR would be placed to the user. The rules engine 221 may also decide to ask the user permission to automatically resolve the issue without further involvement from the user. If permission is granted, then the self-care tool or agent would attempt to resolve the issue and then notify the user of the completion of the task.

The rules engine 221 may categorize the issue to be resolved in terms of how urgent the issue is, how simple the issue is to be resolved, comments left by the user, messages left by the user, other activities initiated by the user after the session termination including phone calls, emails, or messages. For example, the rules engine 221 determines that an issue is urgent (e.g., no service), then an outbound IVR call may immediately be placed to the user. If the rules engine determines that the issue may be easily resolved (e.g., user wished to close an account), then the situation aware IVR may direct that the account be closed without any input on the part of the user. If the rules engine determines that, for example, an issue is more involved or that would require additional user input, then a customer code may sent to the user for the user to call at a later time. Alternatively, a time may be provided to the user as to when an outbound IVR call would be placed to the user.

At step 506, the multi-channel manager 220 may monitor user Internet activity. If the multi-channel manager 220 detects that the user is actively using the Internet, for example, from a laptop or mobile phone, then the multi-channel manager 220 may instruct the situation aware IVR 230 to send a completion code to the user at step 506. If no Internet activity is detected by the multi-channel manager 220 on the part of the user, the multi-channel manager 220 may wait until Internet activity is detected on the part of the user via a user device before instructing that the completion code be sent to the user, or alternatively, could instruct that the completion code be sent to the user without regard to user Internet activity. In any event, the completion code is sent to the user at step 507 via, text, email, pop-up message on a user device, etc.

When the completion code is sent to the user, it may include a telephone number for which the user to dial into the system and reach the situation aware IVR 230, it may include a link for which the user to click in order to access the situation aware IVR, or it may include a time at which the situation aware IVR will place a call to the user. In the present example, the completion code includes a message that the user may call a number to reach the system and be connected with the situation aware IVR 230. At step 508, when the user calls the situation aware IVR 230, the situation aware IVR is already familiar with the workflow 211 of the previous unsuccessful attempt by the user to resolve the issue, by virtue of having received log information from the customer interaction repository 22 and active record context 241.

Thus, the situation aware IVR 230 would receive the call and use an appropriate script to interact with the user to identify and complete the purchase of the particular product or service desired by the user. That is, the user would not have to select a “Purchase new phone” option again. Then, at step 509, the situation aware IVR, operating with the appropriate backend system for the ordering and processing of merchandise, would pass an instruction that the product or service be ordered and shipped to the user. The interaction ends at step 510.

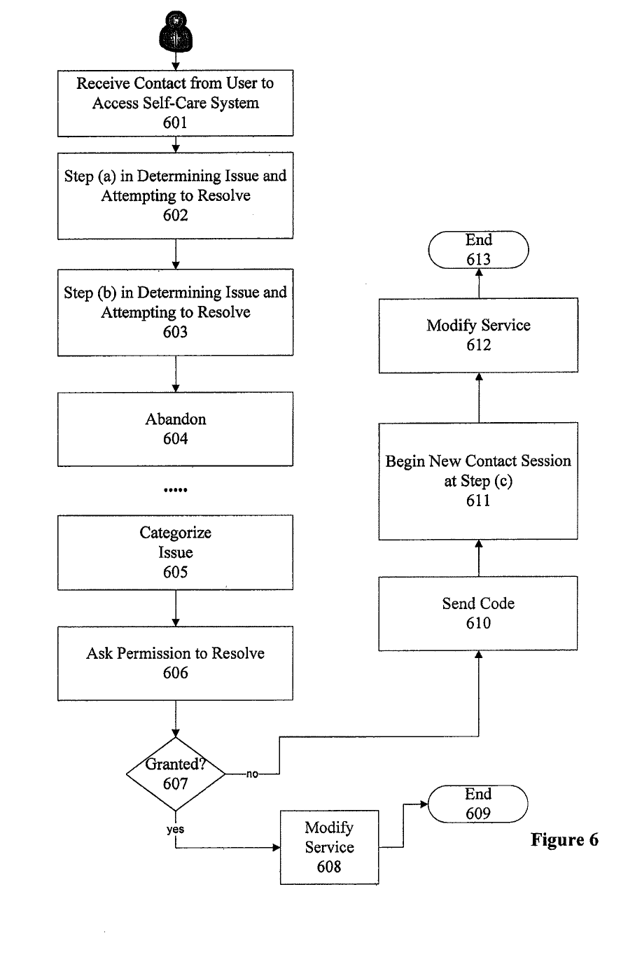

FIG. 6 shows an exemplary process for a customer self-care system, according to an aspect of the present disclosure. At step 601, a user accesses the self-care system to resolve an issue. The self-care system may be reached via a web portal, chat feature, email, or IVR. In FIG. 6, an exemplary issue to be resolved is to modify a service of the user. For example, the user may wish to upgrade a service, add tv channels, etc. At step 602, during interaction with the system, the user interacts with the self-care system to attempt to resolve the issue, in this case, to upgrade or modify a service plan. For example, at step 602, the user indicates a desire to upgrade Internet service to a premium level of service. At step 603, through interaction with the user, the system prompts the user as to whether they are interested in a special promotion with regard to bundling Internet service with a tv service. In this example, the user indicates that they are interested in this special promotion. At step 604, the multi-channel manager 220 detects that the user terminated the session with the self-care system and began other activities indicative of being unsatisfied with the web portal session. For example, activities indicative of dissatisfaction or failed to resolve an issue that are detectable by the multi-channel manager 220 or other sub-system include receipt of a chat message or an email message from the user, phone or Internet activity by the user on a competitor website, etc. For example, the user is intrigued by the special promotion and may be interested in bundling the upgraded Internet service with tv service. However, the user began searching the Internet for competitor promotions with respect to bundled Internet and tv service.

In this regard, the multi-channel manager 220 detects that the user began Internet activity on a competitor website immediately after the session was terminated. Thus, at step 605, the rules engine of the multi-channel manager ruled that the user be contacted in order to receive permission to resolve the issue without further contact from the user.

Thus, at step 606, the multi-channel manager passes a message (e.g., text, email) to the user requesting permission to modify the service in accordance with an understanding of how the user wanted the user's service to be modified at step 603, i.e., upgraded Internet with tv service. If the user responds with permission to modify the service at step 607, then the situation aware IVR 230 passes this user's affirmative response to the IVR server 231, which passes the response to the appropriate sub-system to have the service of the user modified accordingly at step 608. The interaction then ends at step 609. Of course, this may entail scheduling someone to the residence of the user to perform appropriate installation activities. If the user did not grant permission at step 607, then a completion code is sent to the user, in a manner discussed above. That is, at step 610 the completion code is sent to the user via, text, email, pop-up message on a user device, etc.

When the completion code is sent to the user, it may include a telephone number for which the user to dial into the system and be connected with the situation aware IVR 230, it may include a link for which the user to click in order to access the situation aware IVR 230, or it may include a time at which the situation aware IVR 230 will place a call to the user. In the present example, the completion code includes a message that the user should call a number to reach the system and be connected with the situation aware IVR. At step 611, when the user calls the situation aware IVR, the situation aware IVR is already familiar with the workflow 211 of the previous unsuccessful attempt by the user to resolve the issue, by virtue of having received log information from the customer interaction repository 222 and active record context 241. Thus, the situation aware IVR 230 script would begin with the upgraded Internet with tv service promotion.

Thus, the situation aware IVR 230 would receive the call and use an appropriate script to interact with the user to effect the service modification. Then, at step 612, the situation aware IVR 230, operating with the appropriate backend system for the, would pass an instruction to an appropriate backend system that the service be modified. The routine would end at step 613.

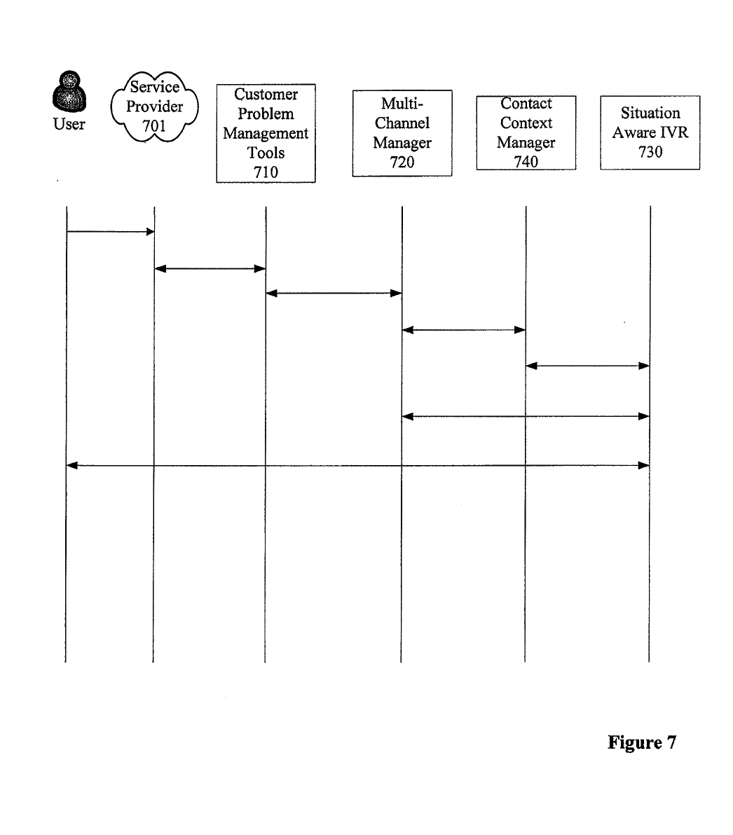

FIG. 7 shows an exemplary communication flow for a self-care system, according to an aspect of the present disclosure. In FIG. 7, a web portal communication session is initiated by the user using a user device through a service provider network 701. The user interacts with the customer problem management tools 710 to attempt to resolve the issue. The interaction may be multiple exchanges between the user and the customer problem management tools 710 whereby the user attempts to identify an issue to be resolved (e.g., ordering a product or service, troubleshooting, upgrading a service, etc.) and then resolve the issue. In doing so, various dialog and interfaces may be presented to the user via the user device. At some point, such as for a reason identified above, the attempt of the user to resolve the issue is unsuccessful and the web portal session is abandoned. During interaction between the user and the customer problem management tools 710, the multi-channel manager 720 monitors all of the web transactions between the user and the multi-channel manager 720. The multi-channel manager 720 identifies that the failed attempt of the user.

Accordingly, the multi-channel manager 720 directs that a log of the failed attempt be sent to the contact context manager 740. The multi-channel manager 720 also categorizes the failed attempt of the user into one of multiple categories for each of which a different option for establishing a second communication to resolve the issue is provided, in which the second communication is established via an access channel distinct from the first access channel. For example, an outbound IVR call with the situation aware IVR 730 may be placed to the user, which is distinct from a web portal channel.

Examples of the multiple categories pertain to a length of the user session, the simplicity of the issue to be resolved, user inactivity during the session (e.g., idle time), a timeout condition when a user fails to respond to a prompt, the nature of a task being performed by the user immediately before the user terminated the session, messages or comments left by the user during the session, emails or other subsequent communications from the user, or activities by the user via other communication channels after session termination (i.e., if the user session was via web access, did the user use a mobile phone or the Internet; is the user using the Internet, is the user's television service in operation). Based upon the identified category, the rules engine in the multi-channel manager will determine the best option for establishing the second communication with the user to resolve the issue.

For example, if the multi-channel manager 720 determines that the issue to be resolved is urgent, the multi-channel manager 720 would direct the situation aware IVR 730 to place an outbound call to the user immediately. The situation aware IVR 730 would receive active context record information from the contact context manager 740 and interaction information from the multi-channel manager 720 to assist in the outbound IVR call to the user. Then, when the user is contacted, resolution of the issue would begin with the step where the failed attempt was abandoned. The situation aware IVR 730 receives an indication from the context manager 740 to enable the situation aware 730 IVR to follow a script beginning where the user left off in the procedure to resolve the issue.

Alternatively, the multi-channel manager 720 may instruct that an outbound IVR call be placed to the user later, that a completion code be sent to the user, or that the user be asked for permission that the issue be resolved without further contact from the user, as discussed above. According to another embodiment, the multi-channel manager may simply determine to automatically resolve the issue without any further contact with the user; although, the user may be contacted upon completion of the task.

The various categories to which the multi-channel manager 720 categorizes the failed attempt may be numbered or otherwise identified by individual identifiers, and then, for each category, a specific method of establishing communication with the user may be assigned.

For example, failed attempts where a user visited a competitor website during or immediately after the web portal session of the use may be categorized in the highest or most urgent category. For failed attempts in the highest or most urgent category, an outbound IVR call would be made to the user immediately. As another example, failed attempts caused by an idle time or timeout condition may be categorized in a moderately urgent category. For failed attempts in a moderately urgent category, a completion code may be sent to the caller for the caller to call later for resolution of the issue. Alternately, a link may be sent to the caller for the caller to click on to connect with the system and proceed with resolution of the issue. As another example, failed attempts where the issue is deemed simple to resolve may be categorized in a semi-urgent category. For failed attempts in a semi-urgent category, the user is sent a message requesting permission to automatically resolve the issue without an IVR call with the user.

As another example, certain failed attempts where the issue requires a higher amount of user input may be assigned a category in which the user must be online to have the issue resolved. In this case, presence information may be used to determine network activity of the user (e.g., is the user using mobile phone, is the user using the Internet, is a user using television service), and a message would be sent to the user on the monitored device with a completion code or other message in which the user would be notified to call for service, that an outbound IVR call will be placed to the user, etc.

For example, the multi-channel manager 720 may monitor or instruct that another element monitor user activity involving a device or network of the user (e.g., landline phone, mobile phone, Internet, tv). Then, the multi-channel manager 720 may send or instruct that an email, text message, call, or pop-up message be sent to the device or network of the user. For a landline phone, this may include a call placed to the user. For a mobile phone, this may include a text message, email, or call to the user. For the Internet, this may include a text message, email, or pop-up message to the user. For the tv, this may include a pop-up message displayed on the tv of the user. The landline phone, mobile phone, Internet, and/or tv of the user may be monitored during or after the failed attempt of the user to determine if the user attempted to pursue additional actions to related to the issue, or merely to identify the best place to contact the user to resolve the issue. The multi-channel manager 720 may direct that the email, text message, or pop-up message be sent to the user device when the user device is in operation, or when the user device is idle, depending upon circumstances.

For example, this information may provide the system with the best communication address at which to contact the user and to initiate an outbound communication. Additionally, this information may be used to request authorization from the user to resolve the issue without further action on the part of the user. A completion code may also be sent to a user device of the user based on presence information obtained about the user.

The presence information may include rich presence information in which the system may determine if the user is online, and if so, what they are doing online, and how they are doing it. This information could include location of the user, whether the device is mobile, the specifications of the device, whether the user is typing or channel surfing, email and text messages of the user, etc. The presence information can be obtained by a presence module in the system (e.g., in the multi-channel manager 720) configured to determine one or more of the aforementioned presence states of the user. The presence information may be passed to the contact context manager 740 and saved in the active context record 741. The presence information can then be used by situation aware IVR 730 under direction of the IVR server. Session Initiation Protocol (SIP) and the Extensible Message and Presence Protocol (XMPP) may be used to communicate information about the presence state of the user.

As indicated, the second communication session with the user is seamless, by virtue of the active context record 241 and web portal activity log being passed to the situation aware IVR 230. Thus, the situation aware IVR 230 can begin the second communication session with the user at the next position in the sequence of resolving the issue, without backtracking or requesting the user to re-input information or re-perform steps.

In one non-limiting exemplary embodiment, the web-portal is configured to follow from one or more sets of scripts in which each script has a defined order. Thus, if interaction with the caller during the first communication was determined to be a failure at prompt number 27, via caller abandonment or otherwise, then the situation aware IVR 230 would begin its script with the next logical prompt, for example, prompt number 28. That is, the situation aware IVR 230 would derive the position in the script from the active context record 241 and web tool activity log.

As another example, a checklist or virtual checklist may be used which during the first communication with the user, a check or virtual check is assigned to each task completed during interaction with the user. Then, when the situation IVR 230 begins with the second communication, the situation aware IVR 230 would begin with the first unchecked item on the list. That is, if after being authenticated in the web portal, the user indicated that the nature of the communication pertained to troubleshooting, this would be the first checkable item. Next, if the user indicated that the device was television service, this would be the second checkable item. Then, if the user indicated that certain television channels were not working, this would be the third checkable item. If the web portal communication were abandoned at this point, the situation aware IVR 230, after receiving the active context record 241 and activity log, would begin the second communication with an exemplary script prompt such as “which channels are not working”, and interaction with the user would proceed from that point on.

As yet another example, user interaction with the web portal may be mapped, for example, in an IVR tree. Then, when the situation aware IVR begins with the second communication, the situation aware IVR 230 would begin with the next sequential item on the particular a branch of the tree down which the user interacted navigated during the first communication. That is, if after being authenticated in the web portal, the user indicated that the nature of the communication pertained to ordering a product, this would be the IVR tree branch down which the user would navigate. Next, if the user indicated that the product related to internet service, this would be the next sequential item down the ordering a product branch. If the web portal communication were abandoned at this point, the situation aware IVR 230, after receiving the active context record and activity log, would begin the second communication with an exemplary script prompt such as “which internet product would you like to order”, and interaction with the user would proceed from that point on.

Although a system of automatically completing a failed self-care attempt has been described with reference to several exemplary embodiments, it is understood that the words that have been used are words of description and illustration, rather than words of limitation. Changes may be made within the purview of the appended claims, as presently stated and as amended, without departing from the scope and spirit of active records for interactive systems in its aspects. Although a system of automatically completing a failed self-care attempt has been described with reference to particular means, materials and embodiments, active records for interactive systems is not intended to be limited to the particulars disclosed; rather active records for interactive systems extends to all functionally equivalent structures, methods, and uses such as are within the scope of the appended claims.

For example, a system of automatically completing a failed self-care attempt is mainly described with respect to products and services of a service provider; however, the system is also applicable to other fields. For example, the user may be a customer of a financial institution and may be attempting to access account information, upgrade an account, close an account, open an account, obtain account information, etc. When the user using a first communication channel such as a web portal fails to resolve of the exemplary issues, then system would automatically resolve the issue using a second communication channel, after having categorized the failed attempt, with one of the aforementioned methods in accordance with the rules of the system.

For another example, the system may be owned or operated by or on behalf of a retailer and the user may be attempting to purchase merchandise, return merchandise, or obtain customer service, etc. When the user using a first communication channel such as a web portal fails to resolve of the exemplary issues, then system would automatically resolve the issue using a second communication channel, after having categorized the failed attempt, with one of the aforementioned methods in accordance with the rules of the system.

Additionally, while session initiation protocol has been specified as the message protocol used herein, any alternative message with a similar purpose and function can be used in the same manner as session initiation protocol messages. Such messages may be first sent and received before communications occur between a user and an interactive system such as an IVR, but otherwise alternative forms of electronic messages can be used in order to obtain the same results as described herein. Such messages are also not limited to internet protocol (IP) based networks, and can be used in networks that use other types of communication protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards noted herein may represent examples of the state of the art. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In accordance with an aspect of the present disclosure, a method of automatically completing a self-care attempt by a user includes receiving a communication from a user via a first communication channel comprising a system configured to be used by users to automatically resolve an issue. Monitoring, using a processor of a computer, of the interaction between the user and the system is performed during the communication, and a result of the monitoring, a failed attempt by the user to resolve an issue is identified. The failed attempt is categorized into one of a plurality of categories for each of which a different option for establishing a second communication to resolve the issue is provided. Then, the second communication is established with the user via a second communication channel distinct from the first communication channel, in accordance with the categorizing, to resolve the failed attempt.

In accordance with another aspect of the present disclosure, monitoring user activity involving a device of the user is performed, and a notification is sent to the device of the user when the monitoring of the user activity indicates that the device is in use. The notification includes an identifier to allow the user to begin the second communication at a location in the interaction at which the failed attempt ended.

In accordance with still another aspect of the present disclosure, the monitored device includes a television and the notification comprises sending a message to be displayed on the television.

In accordance with yet another aspect of the present disclosure, the first communication channel is a web portal, and the device is a portable communications device.

In accordance with still another aspect of the present disclosure, the method includes monitoring a communication channel of the user distinct from the first communication channel, after the failed attempt, to determine if the user attempted to pursue additional actions related to the issue, after the failed attempt.

In accordance with yet another aspect of the present disclosure, the method also includes initiating an interactive voice response communication to the user, and resolving the issue.

In accordance with still another aspect of the present disclosure, the user is automatically contacted based on the categorizing, via the second communication channel, and then the method begins to resolve the issue beginning at a position in the interaction at which the failed attempt to resolve the issue ended.

In accordance with another aspect of the present disclosure, the method also includes sending an identifier to the user based on the categorizing, receiving the second communication from the user, and attempting to resolve the issue beginning at a position in the interaction at which the failed attempt to resolve the issue ended.

In accordance with another aspect of the present disclosure, the method also includes determining a communication address at which to contact the user, and initiating an outbound communication to the user at the communication address.

In accordance with still another aspect of the present disclosure, authorization is requested from the user to automatically to resolve the issue without further action on the part of the user. In this regard, the method also includes resolving the issue if authorization from the user is received. If authorization from the user is not received, the method includes sending an identifier to the user, receiving the second communication from the user, and attempting to resolve the issue beginning at a position in the interaction at which the failed attempt to resolve the issue ended.

In accordance with still another aspect of the present disclosure, the second communication of the user is initiated in response to user selection of a link sent to the user with the identifier.

In accordance with another aspect of the present disclosure, the categorizing is based upon a determined simplicity of resolving the issue.

In accordance with yet another aspect of the present disclosure, the method also includes initiating the second communication to the user via a social media application in order to resolve the issue.

In accordance with yet another aspect of the present disclosure, the identifying is based upon one of a timeout and an idle user device condition.

In accordance with still another aspect of the present disclosure, the method includes initiating the second communication to the user based upon a detected user activity after termination of the interaction.

In accordance with yet another aspect of the present disclosure, the method includes contacting the user to initiate the second communication after a delay beginning after the failed attempt, and monitoring user email activity associated with the issue during the delay.

In accordance with yet another aspect of the present disclosure the method also includes contacting the user to initiate the second communication after a delay beginning after the failed attempt, and monitoring user text messaging activity associated with the issue during the delay.

In accordance with still another aspect of the present disclosure, the method also includes using information obtained from the monitoring in performing the categorizing.

According to another aspect of the present disclosure, a computer system includes a memory that stores instructions for completing a failed attempt of a user to resolve an issue using a self-care system, and a processor that executes the instructions. When executed by the processor, the instructions cause the processor to perform operations. The operations include receiving a communication from a user via a first communication channel comprising a system configured to be used by users to automatically resolve an issue. The operations also include monitoring, using a processor of a computer, interaction between the user and the system during the communication. The operations also include identifying, as a result of the monitoring, a failed attempt by the user to resolve an issue. The operations also include categorizing the failed attempt into one of a plurality of categories for each of which a different option for establishing a second communication to resolve the issue is provided. The operations also include establishing the second communication with the user via a second communication channel distinct from the first communication channel, in accordance with the categorizing, to resolve the failed attempt.

In accordance with another aspect of the present disclosure, a tangible computer-readable storage medium stores a computer program for providing automatically completing a self-care attempt by a user. The computer program, when executed by a processor, causes a computer apparatus to perform a process that includes receiving a communication from a user via a first communication channel comprising a system configured to be used by users to automatically resolve an issue. The process also includes monitoring, using a processor of a computer, interaction between the user and the system during the communication. The process also includes identifying, as a result of the monitoring, a failed attempt by the user to resolve an issue. The process also includes categorizing the failed attempt into one of a plurality of categories for each of which a different option for establishing a second communication to resolve the issue is provided. The process also includes establishing the second communication with the user via a second communication channel distinct from the first communication channel, in accordance with the categorizing, to resolve the failed attempt.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method of automatically completing a self-care attempt by a user, comprising:
receiving a communication from a user via a first communication channel comprising a system configured to be used by users to automatically resolve an issue;
monitoring, using a processor of a computer, interaction between the user and the system during the communication;
identifying, as a result of the monitoring, a failed attempt by the user to resolve an issue;
categorizing the failed attempt into one of a plurality of categories for each of which a different option for establishing a second communication to resolve the issue is provided;
establishing the second communication with the user via a second communication channel distinct from the first communication channel, in accordance with the categorizing, to resolve the failed attempt.

2. The method of claim 1, further comprising:
monitoring user activity involving a device of the user; and
sending a notification to the device of the user when the monitoring the user activity indicates that the device is in use,
wherein the notification comprises an identifier to allow the user to begin the second communication at a location in the interaction at which the failed attempt ended.

3. The method of claim 2, wherein the device comprises a television and the notification comprises sending a message to be displayed on the television.

4. The method of claim 2,
wherein the first communication channel comprises a web portal, and
wherein the device comprises a portable communications device.

5. The method of claim 1, further comprising:
monitoring a communication channel of the user distinct from the first communication channel, after the failed attempt, to determine if the user attempted to pursue additional actions related to the issue, after the failed attempt.

6. The method of claim 1, further comprising:
initiating an interactive voice response communication to the user; and
resolving the issue.

7. The method of claim 1, further comprising:
automatically contacting the user, based on the categorizing, via the second communication channel; and
beginning to resolve the issue beginning at a position in the interaction at which the failed attempt to resolve the issue ended.

8. The method of claim 1, further comprising:
sending an identifier to the user based on the categorizing;
receiving the second communication from the user; and
attempting to resolve the issue beginning at a position in the interaction at which the failed attempt to resolve the issue ended.

9. The method of claim 1, further comprising:
determining a communication address at which to contact the user; and
initiating an outbound communication to the user at the communication address.

10. The method of claim 1, further comprising:
requesting authorization from the user to automatically to resolve the issue without further action on the part of the user;
resolving the issue if authorization from the user is received, and if authorization from the user is not received:
sending an identifier to the user;
receiving the second communication from the user;
attempting to resolve the issue beginning at a position in the interaction at which the failed attempt to resolve the issue ended.

11. The method of claim 10, wherein the second communication of the user is initiated in response to user selection of a link sent to the user with the identifier.

12. The method of claim 1, wherein the categorizing is based upon a determined simplicity of resolving the issue.

13. The method of claim 1, further comprising initiating the second communication to the user via a social media application in order to resolve the issue.

14. The method of claim 1, wherein the identifying is based upon one of a timeout and an idle user device condition.

15. The method of claim 1, further comprising initiating the second communication to the user based upon a detected user activity after termination of the interaction.

16. The method of claim 1, further comprising contacting the user to initiate the second communication after a delay beginning after the failed attempt; and
monitoring user email activity associated with the issue during the delay.

17. The method of claim 1, further comprising contacting the user to initiate the second communication after a delay beginning after the failed attempt; and
monitoring user text messaging activity associated with the issue during the delay.

18. The method of claim 16, further comprising using information obtained from the monitoring in performing the categorizing.

19. A computer system, comprising:
a memory that stores instructions for completing a failed attempt of a user to resolve an issue using a self-care system, and
a processor that executes the instructions,
wherein, when executed by the processor, the instructions cause the processor to perform operations comprising:
receiving a communication from a user via a first communication channel comprising a system configured to be used by users to automatically resolve an issue;
monitoring, using a processor of a computer, interaction between the user and the system during the communication;
identifying, as a result of the monitoring, a failed attempt by the user to resolve an issue;
categorizing the failed attempt into one of a plurality of categories for each of which a different option for establishing a second communication to resolve the issue is provided;
establishing the second communication with the user via a second communication channel distinct from the first communication channel, in accordance with the categorizing, to resolve the failed attempt.

20. A tangible computer-readable storage medium encoded with an executable computer program for providing automatically completing a self-care attempt by a user and that, when executed by a processor, causing a computer apparatus to perform a process comprising:
receiving a communication from a user via a first communication channel comprising a system configured to be used by users to automatically resolve an issue;
monitoring, using a processor of a computer, interaction between the user and the system during the communication;
identifying, as a result of the monitoring, a failed attempt by the user to resolve an issue;
categorizing the failed attempt into one of a plurality of categories for each of which a different option for establishing a second communication to resolve the issue is provided;
establishing the second communication with the user via a second communication channel distinct from the first communication channel, in accordance with the categorizing, to resolve the failed attempt.
